(19) United States
(12) Patent Application Publication
(10) Pub. No.: US 2026/0348457 A1
(43) Pub. Date: Nov. 5, 2026

(54) Anti-Chatter Screw Thread Linear Motion Drive And Related Devices and Methods

(71) Applicant: Boost Treadmills, LLC, Palo Alto, CA (US)

(72) Inventors: Sean Tremaine Whalen, Mountain View, CA (US); Robert Tremaine Whalen, Los Altos, CA (US)

(21) Appl. No.: 19/665,130

(22) Filed: May 1, 2026

Related U.S. Application Data
(60) Provisional application No. 63/798,814, filed on May 2, 2025.

(51) Int. Cl. F16H 25/20; F16M 11/04; F16M 11/22

(52) U.S. Cl. CPC F16H 25/2003; F16M 11/046; F16M 11/22; F16H 2025/2031

(57) ABSTRACT

A linear drive system comprises a lead screw with external threads that is operatively connected to a drive motor, and a lead nut that is threadingly mated with the lead screw. The linear drive system further comprises a housing defining an interior bore therethrough disposed about an exterior of the lead nut, whereby the interior bore and the exterior of the lead nut define a gap therebetween, such that the lead nut floats within the housing. A bias member can be connected to both the lead nut and the housing interior bore, which urges the lead nut laterally toward the lead screw when the drive motor rotates the lead screw and the lead nut moves along the lead screw. The linear drive system can be incorporated into lift columns, differential air pressure (DAP) systems, and/or other assemblies to eliminate or mitigate chatter and/or backlash.

### CROSS-REFERENCE TO RELATED APPLICATIONS

This application claims the benefit of, and priority to, U.S. Provisional Patent Application No. 63/798,814 filed on May 2, 2025. The content of the aforementioned application is herein incorporated by reference in its entirety.

### TECHNICAL FIELD

The present disclosure relates generally to linear drive systems and, more particularly, to lead screw linear drive systems having anti-chatter lead nut assemblies. In some exemplary embodiments, the lead screw linear drive systems can be incorporated into lift columns, differential air pressure systems, exercise systems, rehabilitation systems, and/or other types of assemblies.

Certain aspects, features, and concepts described herein relate to supplemental equipment for exercise and rehabilitation devices, and particularly to equipment known as unweighting, antigravity, or differential air pressure DAP systems, devices and methods, as well as to related devices, systems and methods for use with DAP systems and devices.

### BACKGROUND

Linear motion drive systems including lead screw and ball screw systems are incorporated into a broad range of applications. Typically, they provide a stiff platform for reasonably precise positioning with the capacity to drive high loads. Such applications include 3D printers, machine tools, and linear actuators, as well as for differential air pressure DAP systems with powered height adjustment. For applications requiring higher precision under load, the lead screw system is often replaced by a considerably more expensive ball screw system. Exemplary types of lead screw systems include those based on the ACME (Imperial) threads and those based on trapezoidal (Tr) metric threads. While the dimensions between the two are different, the thread profiles are nearly identical. Both lead screw systems have the significant advantage of being non-backdrivable with the selection of the appropriate thread pitch. This means that the lead screw can hold a high load in place without the use of a brake.

Typically, the thread of a lead nut for a lead screw of such systems matches the thread of the lead screw with sufficient clearance between the nut and screw for the nut to slide smoothly along the lead screw. This clearance causes two related problems: backlash and chatter.

Backlash refers to the amount of rotation of the lead screw that occurs before the lead nut moves up or down. For example, for a lead screw having a pitch of 5 millimeters (mm), a lead nut with zero backlash would move up or down 5 mm with each rotation of the lead screw. If, however, the lead screw rotates ¼ turn without moving the lead nut, then the total backlash is 5/4 mm (1.25 mm or 0.049 inches (in)), and the nut would only move 3.75 mm, which is the difference between 5.00 mm-1.25 mm. Backlash is a problem when a precision higher than the backlash is required and the lead screw is reversing direction.

Chatter refers to a rapid vibration between the lead nut and the lead screw. This is caused by differences in the static and dynamic coefficients of friction between two surfaces that have some clearance, which allows the surfaces to vibrate against each other.

Ball screws differ from lead screws in the design of the nut and the profile of the screw. Recirculating ball bearings roll in the ball screw profile as the nut traverses up and down the screw. Because rolling friction is very low, ball screw systems are highly efficient, and the close tolerance between the nut and the screw can reduce or eliminate chatter and backlash. However, ball screw systems are backdrivable and more expensive.

Various manufacturers produce anti-backlash nuts with different configurations. While design details may vary among these products, the products generally address backlash in a similar manner. In particular, the products are configured to reduce clearance between the nut and the lead screw such that the nut and the lead screw remain in contact along at least a portion of the nut. As a result, rotation of the lead screw in either a clockwise direction or a counterclockwise direction, even by a small amount, causes corresponding displacement of the carriage, either in the upward or downward direction. This is accomplished by forcing the lead nut into contact with the lead screw. Either axial clearance between nut and screw is reduced by pushing two parts of the nut apart on the lead screw, or radial clearance is reduced between the lead nut and lead screw by squeezing radially on the lead nut.

These aforementioned anti-backlash nut solutions have limitations. First, tighter tolerances generally increase friction, which can require more power to drive the system and can increase wear on the lead nut. Second, such solutions may perform poorly under high axial loads.

Accordingly, a need exists for a non-backdrivable lead screw linear drive system capable of withstanding high axial loads while reducing or eliminating backlash and reducing vibration or chatter during high-speed operation.

The background description provided herein is for the purpose of presenting the context of the disclosure. The subject matter described in this section is not prior art to the claims in this application and is not admitted to be prior art, or suggestions of the prior art.

### BRIEF DESCRIPTION OF DRAWINGS

Non-limiting and non-exhaustive examples are described with reference to the following figures. To facilitate further description of the embodiments, the following drawings are provided, in which like references are intended to refer to like or corresponding parts.

FIG. 1A is a right perspective view of an example of a differential air pressure (DAP) system having a pair of example column drives shown in a low position in accordance with inventive aspects, features and concepts described herein.

FIG. 1B is right perspective view of the example DAP and pair of column drives of FIG. 1B shown in a raised position.

FIG. 1C is an inboard perspective view of one of the column drives FIG. 1A in accordance with inventive aspects, features and concepts described herein.

FIG. 1D is an outboard perspective view of one of the column drives FIG. 1A in accordance with inventive aspects, features and concepts described herein.

FIG. 1E is an exploded view of the column drive depicted in FIG. 1C.

FIG. 2 is a cross-sectional view of the extruded body of the column drive depicted in FIG. 1E.

FIG. 3 is a perspective view of the carriage body of the column drive depicted in FIG. 1E.

FIG. 4 is a cross-sectional view of the carriage body shown in FIG. 3.

FIG. 5 is a perspective view of an antichatter lead nut assembly 1A in accordance with inventive aspects, features and concepts described herein.

FIG. 6 is an elevation view of another assembly of a lead nut with a top cap and a bottom cap in accordance with inventive aspects, features and concepts described herein.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

As used herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

The terms “connect,” “connected,” “connects,” “connecting,” “couple,” “coupled,” “couples,” “coupling,” and the like should be broadly understood and refer to linking two or more elements or signals, electrically, electronically, mechanically and/or otherwise. Connecting/coupling may be for any length of time, e.g., permanent or semi-permanent or only for an instant. “Electrical connecting,” “electrical coupling,” and the like should be broadly understood and include connecting/coupling involving any electrical signal, whether a power signal, a data signal, and/or other types or combinations of electrical signals. “Mechanical connecting,” “mechanical coupling,” and the like should be broadly understood and include physical or mechanical connecting/coupling of all types.

Each statement of an arrangement is to be considered independent of any other statement of an arrangement despite any use of similar or identical language characterizing each arrangement. Therefore, where one arrangement is identified as “another arrangement,” the identified arrangement is independent of any other arrangements characterized by the language “another arrangement.” The independent arrangements are considered to be able to be combined in whole or in part one with another as the claims and/or art may direct, either directly or indirectly, implicitly, or explicitly.

Further, the fact that the wording “an arrangement,” or the like, do not appear at the beginning of every sentence in the specification, such as is the practice of some practitioners, is merely a convenience for the reader's clarity. However, it is the intention of this application to incorporate by reference the phrasing “an arrangement,” and the like, at the beginning of every sentence herein where logically possible and appropriate.

References for “herein” or similar terminology including “used herein,” “shown herein” or “discussed herein” are understood to mean the instant patent application, as well as all related patent applications incorporated by reference and/or identified in the present application. Further, references for “herein: and the like are understood to include anticipated patent application filings for related subject matter and improvements including provisional or non-provisional patent applications that denote, identify or incorporate by reference the instant patent application.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

As used herein, the term “about” when used in connection with a referenced numeric indication means the referenced numeric indication plus or minus up to 10 percent of that referenced numeric indication. For example, the language “about 50” covers the range of 45 to 55. Similarly, the language “about 5” covers the range of 4.5 to 5.5.

As used in this specification and the appended claims, the words “top,” “above,” and “upward” refer to elevation directions away from the ground level of an exercise device in its typical or intended usage orientation at or towards a higher elevation, and the words “bottom,” “below,” “base” and “downward” refer to elevation directions at or towards the ground level of an exercise device at a lower elevation in its typical usage orientation. Thus, for example, the top of a structure for an exercise device that is farthest from the ground level of the exercise device would be the vertical distal end of the structure, and the end opposite the vertical distal end i.e., the end interfacing with the exercise device closest to ground level would be the vertical base or bottom end of the structure.

Further, specific words chosen to describe one or more arrangements and optional elements, or features are not intended to limit the scope of embodiments. For example, spatially relative terms-such as “beneath,” “below,” “lower,” “above,” “upper,” “proximal,” “distal,” and the like-may be used to describe the relationship of one element or feature to another element or feature as illustrated in the figures. These spatially relative terms are intended to encompass different positions i.e., translational placements and orientations i.e., rotational placements of a device in use or operation in addition to the position and orientation shown in the figures. For example, if a device in the figures were turned over, elements described as “below”, or “beneath” other elements or features would then be “above” or “over” the other elements or features. Thus, the term “below” may encompass both positions and orientations of above and below. A device may be otherwise oriented e.g., rotated 90 degrees or at other orientations and the spatially relative descriptors used herein interpreted accordingly. Likewise, descriptions of movement along translation and around rotation various axes include various spatial device positions and orientations.

Similarly, geometric terms, such as “parallel,” “perpendicular,” “round,” “curvilinear,” “articulated” or “square,” are not intended to require absolute mathematical precision, unless the context indicates otherwise. Instead, such geometric terms allow for variations due to manufacturing or equivalent functions. For example, if an element is described as “round” or “generally round,” a component that is not precisely circular e.g., one that is slightly oblong or is a many-sided polygon is still encompassed by this description.

In addition, the singular forms “a,” “an,” and “the” are intended to include the plural forms as well, unless the context indicates otherwise. The terms “comprises,” “includes,” “has,” and the like specify the presence of stated features, steps, operations, elements, components, etc., but do not preclude the presence or addition of one or more other features, steps, operations, elements, components, or groups.

Unless indicated otherwise, the terms exercise apparatus, device, equipment, systems, and variants thereof, may be interchangeably used.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

This disclosure describes, inter alia, systems, apparatuses, assemblies, and methods for eliminating, or at least reducing, chatter and/or backlash in lead screw linear drive systems that overcome some or all of the aforementioned challenges and shortcomings described above. Additionally, the embodiments of the lead screw linear drive system described herein can be integrated with systems, devices, or apparatuses that require high precision under load, while providing a cost-effective alternative to more expensive options, such as ball screw systems.

In certain embodiments, a lead screw linear drive system is disclosed that includes a lead screw, a lead nut threadingly engaged with the lead screw, a housing or carriage defining a bore that receives the lead nut, and a biasing member configured to urge the lead nut laterally relative to the lead screw.

The arrangement and configuration of the lead screw linear drive system can vary. In certain embodiments, the lead screw linear drive system may include a lead screw having external threads extending substantially along a length of the lead screw and operatively connected at a first end region to a drive motor, a lead nut threadingly mated with the lead screw having internal threads engaging a corresponding region of the external threads, a housing, and a bias member. The housing may define an interior bore therethrough disposed about an exterior of the lead nut, and the interior bore and the exterior of the lead nut may define a gap therebetween, such that the lead nut floats within the housing. The bias member may be connected at a first side to a first one of a lateral portion of the lead nut and the housing interior bore, and at an opposite second side to a second one of the lateral portion of the lead nut and the housing interior bore, such that the bias member applies a lateral spring force against the floating lead nut, such that the lead nut internal threads are biased against the lead screw external threads during rotation of the lead screw for traveling along of the length lead screw substantially without chatter.

In certain embodiments, the lead screw linear drive system may be integrated with a lift column. The lift column may be coupled to, or include, a carriage movable along one or more rails in response to rotation of the lead screw, with the lead nut coupling the carriage to the lead screw. One or more motor assemblies may be coupled to the lead screw, a column housing, and/or extrusion that supports and guides the vertical movement of the carriage.

In certain embodiments, a differential air pressure (DAP) system can incorporate one or more lift columns, each of which includes an independent lead screw linear drive system. The DAP system may include a platform, an inflatable enclosure attached to the platform, and a seal frame coupled to an upper portion of the inflatable enclosure, with the one or more lift columns configured to raise, lower, and hold the seal frame at a selected height. In some embodiments, left and right lift columns may be positioned on opposite sides of the seal frame and may be controlled to adjust the height of the inflatable enclosure during user entry, connection, exercise, and exit operations. The lift columns may be configured to move the inflatable enclosure under relatively low loads during height adjustment and to hold position under higher loads generated when the inflatable enclosure is pressurized.

In certain embodiments, the differential air pressure (DAP) system may be integrated with an exercise device, system, or assembly. In some examples, the DAP system can be integrated with a treadmill device or assembly in order to provide unweighting capabilities, e.g., which reduce an effective body weight of a user supported on the treadmill and thereby reduce loading on the user's lower extremities during walking, running, or rehabilitation. The DAP systems and corresponding lead screw linear drive systems described herein can be integrated with other types of exercise devices, systems, or assemblies including, but not limited to, other exercise devices, systems, or assemblies that provide unweighting capabilities.

The embodiments of the lead screw linear drive system described herein can incorporate various enhancements that assist with reducing the with backlash, chatter, and/or other challenges associated with traditional lead screw linear drive systems. Exemplary enhancements can include any or all of the features described below.

In certain embodiments, the lead screw linear drive system can include a floating anti-chatter lead nut arrangement. In this arrangement, a lead nut is received within an interior bore of a carriage or housing and is not rigidly fixed relative to the carriage or housing. A clearance between an exterior surface of the lead nut and the interior bore permits the lead nut to shift laterally relative to the carriage or housing while remaining threadingly engaged with the lead screw.

In certain embodiments, the lead screw linear drive system can include a lateral biasing member configured to urge the floating lead nut toward the lead screw to reduce chatter. The lateral biasing member may include a spring, such as a linear wave spring, positioned between a lateral portion of the lead nut and the carriage or housing defining the interior bore. The lateral biasing member applies a lateral force to the lead nut such that internal threads of the lead nut are biased against external threads of the lead screw as the lead nut travels along the lead screw.

In certain embodiments, the lead screw linear drive system can include an anti-chatter lead nut assembly configured to reduce vibration or chatter while retaining non-backdrivable operation of the lead screw linear drive system. The anti-chatter lead nut assembly may reduce backlash and chatter while allowing the lead screw linear drive system to hold axial loads without requiring a separate brake.

In certain embodiments, the anti-chatter lead nut assembly can include a lead nut threadingly engaged with the lead screw and received within a bore of a carriage or housing, a retaining cap configured to retain the lead nut within the bore, and a biasing member positioned to urge the lead nut laterally toward the lead screw.

In certain embodiments, the lead nut may be received within the bore with sufficient clearance to permit limited lateral movement of the lead nut relative to the carriage or housing while maintaining threaded engagement with the lead screw. The biasing member may apply a lateral force that biases internal threads of the lead nut against external threads of the lead screw, thereby reducing clearance between the lead nut and the lead screw and reducing vibration or chatter during operation of the lead screw linear drive system. In some embodiments, the lead nut and the retaining cap may include corresponding angled contact surfaces configured to convert axial loading on the lead nut into an additional lateral force urging the lead nut toward the lead screw.

In certain embodiments, the corresponding angled contact surfaces can include one or more slanted surfaces on an axial end of the lead nut and one or more complementary slanted surfaces on the retaining cap. When an axial load is applied to the lead nut, the slanted surfaces can bear against one another and generate a lateral force component that urges the lead nut toward the lead screw. This load-responsive lateral force can supplement the force applied by the biasing member, thereby increasing engagement between the lead nut and the lead screw when the lead screw linear drive system is subjected to axial loading.

In certain embodiments, the anti-chatter lead nut assembly can provide a combined spring-and-ramp anti-chatter mechanism. With this mechanism, the biasing member can provide an initial lateral force that urges the lead nut toward the lead screw, while the corresponding angled contact surfaces can provide a load-responsive lateral force when the lead nut is subjected to axial loading. The spring-generated lateral force and the load-responsive lateral force can act together to maintain engagement between the internal threads of the lead nut and the external threads of the lead screw, thereby reducing chatter during operation.

In certain embodiments, the anti-chatter lead nut assembly can be configured to reduce chatter under axial loading in either axial direction. For example, the lead nut can include first slanted contact surfaces at a first axial end of the lead nut and second slanted contact surfaces at a second axial end of the lead nut. A first retaining cap and a second retaining cap can include complementary slanted contact surfaces configured to engage the first and second slanted contact surfaces, respectively, such that axial loading in either direction generates a lateral force component urging the lead nut toward the lead screw.

In certain embodiments, an angle of the slanted contact surfaces can be selected based at least in part on frictional characteristics of the materials forming the lead nut and the retaining cap. For example, the angle may be selected based on a static coefficient of friction between a polymer material of the lead nut and an aluminum material of the retaining cap. In some embodiments, the angle can be about 12 degrees for a polymer lead nut engaging an aluminum retaining cap, although other angles may be used for different material combinations, load conditions, or desired lateral force characteristics.

In certain embodiments, the anti-chatter lead nut assembly can incorporate a design that facilitates replacement of the lead nut with ease without specialized tooling. For example, the retaining cap can be removed from the carriage or housing to expose the lead nut, the lead nut can be removed from the bore, a replacement lead nut can be inserted into the bore, and the retaining cap can be reattached.

In certain embodiments, the anti-chatter lead nut assembly can accommodate lead nuts formed from different materials. In some examples, the lead nut may be formed from a polymer material, including an unlubricated polymer material, or from a metal material, such as brass. The floating and laterally biased arrangement described herein can permit such materials to be used while reducing chatter that may otherwise occur, particularly during higher-speed operation.

In certain embodiments, the lead nut can be formed from a polymer material having a solid lubricant embedded therein. For example, the lead nut may be formed from nylon including molybdenum disulfide or another solid lubricant. Such a lead nut may be used with a stainless steel lead screw or another suitable lead screw material, thereby reducing or eliminating the need for grease lubrication while maintaining reduced chatter during operation of the lead screw linear drive system.

In certain embodiments, the lead screw linear drive system can be configured to operate at rotational speeds closer to a critical speed of the lead screw than prior lead nut arrangements. By reducing chatter between the lead nut and the lead screw, the anti-chatter lead nut assembly can permit higher-speed operation while maintaining stable engagement between the internal threads of the lead nut and the external threads of the lead screw. In some embodiments, this can allow the lead screw linear drive system to use a longer lead screw, a smaller-diameter lead screw, a higher lead screw rotational speed, or any combination thereof.

In certain embodiments, a carriage of the lead screw linear drive system can include a bearing arrangement configured to accommodate manufacturing tolerances and reduce over-constraint during movement along one or more rails. For example, the carriage may include a first set of bearing bores on a first lateral side of the carriage and a second set of bearing bores on a second lateral side of the carriage. The first set of bearing bores may have a generally circular profile to locate corresponding bearings relative to a first rail, while the second set of bearing bores may have a generally oval or elongated profile that permits corresponding bearings to float laterally relative to a second rail. This arrangement can accommodate spacing variations between the rails while allowing the carriage to move smoothly along the rails.

In certain embodiments, the lead screw linear drive system can include a bearing housing arrangement configured to reduce over-constraint of the lead screw and improve alignment of the lead screw relative to the carriage. For example, a bearing housing supporting the lead screw may be attached to a back wall of a column housing or other support structure while remaining decoupled from one or more additional walls that could otherwise impose conflicting positional constraints. In some embodiments, hardened pins can be used to locate the bearing housing relative to the back wall and to carry loads applied through the bearing housing. This arrangement can reduce misalignment of the lead screw and thereby reduce vibration, motor wobble, increased motor current, increased noise, and additional chatter between the lead nut and the lead screw.

In certain embodiments, the lead screw linear drive system can be incorporated into a lift column designed to support high axial loads. For example, the lift column may be configured to move a relatively low load during height adjustment and to thereafter hold a substantially higher axial load during operation of an associated system. In some embodiments described herein, the lift column may be used in a DAP system in which the lift column adjusts a height of an inflatable enclosure or a seal frame and then maintains the selected height while the inflatable enclosure is pressurized.

In certain embodiments, the lift column configurations described herein withstand high upward loads while maintaining non-backdrivable operation of the lead screw linear drive system. For example, the lift column may be configured to resist upward forces generated during pressurized operation of the differential air pressure system, including forces of about 500 pounds to about 600 pounds per lift column under certain operating conditions. Additionally, the non-backdrivable lead screw arrangement can permit the lift column to hold the selected position under such loads without requiring a separate brake.

In certain embodiments, the lift column described herein can be integrated into a differential air pressure exercise or rehabilitation system. The lift column may be configured to raise, lower, and hold a seal frame, an inflatable enclosure, or both at a selected height based on characteristics of a user or an intended exercise or rehabilitation activity. For example, the lift column may adjust the height of the seal frame or inflatable enclosure during user entry, connection of the user to the inflatable enclosure, exercise or rehabilitation movement, pressurized operation, and user exit.

In certain embodiments, the differential air pressure system can include a powered height-adjustable arrangement having paired non-backdrivable screw-drive lift columns. For example, a left lift column and a right lift column may be coupled to a platform and to opposite sides of a seal frame, with each lift column including a respective lead screw linear drive system. The lift columns may be actuated to position the seal frame at a selected height corresponding to a user height, a desired exercise position, or another operating condition, and the non-backdrivable lead screw linear drive systems may maintain the selected height when the inflatable enclosure is pressurized.

Other drive-related systems, components, and/or methods according to embodiments will be or become apparent to one with skill in the art upon review of the following drawings and detailed description. It is intended that all such additional devices, related components, systems, and/or methods included within this description be within the scope of this disclosure.

The lead screw linear drive systems described herein can be used in a variety of different systems, devices, and assemblies.

As described in various portions of this disclosure, the lead screw linear drive systems described herein can be incorporated into one or more lift columns configured to raise, lower, and hold a supported component at a selected height (which is not limited to supporting the components of a DAP system, but rather any height-adjustable component). For example, each lift column can include a lead screw, a lead nut threadingly engaged with the lead screw, a carriage coupled to the lead nut, and a motor configured to rotate the lead screw to drive linear movement of the carriage. The anti-chatter lead nut assembly can reduce vibration or chatter during movement of the carriage and can maintain non-backdrivable operation so that the lift column can hold a selected position under axial load without requiring a separate brake.

In certain embodiments, the lead screw linear drive systems can be used in exercise devices, rehabilitation devices, or body-support systems in which a component is moved to a selected position and then held under load. For example, the lead screw linear drive systems may be used to adjust and hold frames, supports, platforms, handles, harness supports, therapy structures, patient support components, or other movable components that are subjected to static or dynamic loading during use. In such systems, the reduced chatter and non-backdrivable load-holding capability can facilitate controlled positioning while reducing or eliminating the need for a separate braking mechanism.

In additional embodiments, the lead screw linear drive systems can be used in industrial, manufacturing, and/or automation equipment requiring controlled linear movement under load. For example, the lead screw linear drive systems may be incorporated into adjustable fixtures, positioning stages, conveyor height adjusters, machine guards, tooling supports, lift tables, workpiece supports, packaging equipment, or material-handling assemblies. The anti-chatter configuration may be useful where a cost-effective lead screw drive is desired and where stable motion, reduced backlash, and load-holding capability are beneficial.

In additional embodiments, the lead screw linear drive systems can be used in medical, ergonomic, or assistive devices having height-adjustable or position-adjustable structures. For example, the lead screw linear drive systems may be incorporated into beds, chairs, examination tables, therapy tables, standing frames, mobility devices, patient transfer devices, or adjustable workstations. In these applications, the lead screw linear drive system may move a supported structure during adjustment and then maintain the supported structure at a selected position under load.

In additional embodiments, the lead screw linear drive systems can be used in architectural, furniture, or equipment-mounting assemblies. For example, the lead screw linear drive systems may be used to adjust panels, barriers, shelves, tables, displays, equipment mounts, access doors, or other movable structures. The anti-chatter lead nut assembly can allow the system to provide smoother motion at higher operating speeds while the non-backdrivable lead screw arrangement can maintain a selected position after adjustment.

In additional embodiments, the lead screw linear drive systems can be used in any system, device, or assembly in which a lead screw actuator is used to move a component along a linear path while reducing chatter, reducing backlash, and holding position under axial load. The lead screw linear drive systems may be scaled or adapted for different stroke lengths, load capacities, lead screw diameters, lead screw materials, lead nut materials, motor types, and mounting arrangements according to the requirements of a particular application.

The lead screw linear drive systems can be utilized in many other contexts and environments in addition to those explicitly mentioned herein.

The embodiments described in this disclosure can be combined in various ways. Any aspect or feature that is described for one embodiment can be incorporated into any other embodiment mentioned in this disclosure. Moreover, any of the embodiments described herein may be hardware-based, may be software-based, or may comprise a mixture of both hardware and software elements. Thus, while the description herein may describe certain embodiments, features, or components as being implemented in software or hardware, it should be recognized that any embodiment, feature, and/or component referenced in this disclosure can be implemented in hardware and/or software.

### Exemplary DAP System Having a Pair of Exemplary Linear Screw Drive Lifts and Exemplary Operations Thereof

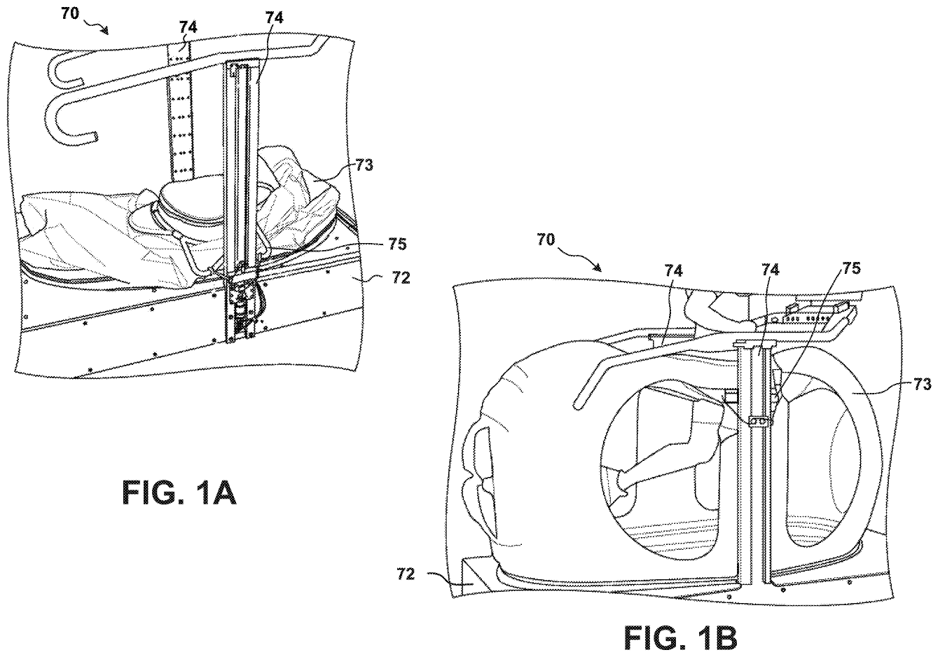

Referring now to FIGS. 1A and 1B, an example DAP System 70 is generally shown having a platform 72, an enclosure 73 attached at its base thereto, a pair of vertical lifts 74 integrally attached at base ends to the platform, and a seal frame 75 attached to the enclosure at a top port thereof, in which a lifting system is formed via the pair of vertical lifts 74 integrated with the platform 72 at their base ends and attached to opposite sides of the seal frame 75. The lifting system may connect with the seal frame 75 via opposing pairs of flexible, high tensile strength restraints for performing initial lift operations and for selective connection with opposite sides of the seal frame 75 in a hybrid support for using the DAP System.

The lifting system generally includes a left lift 74 and an opposite right lift 74, and an attachment mechanism for each lift to connect and disconnect with opposite sides of a seal frame 75 having a plurality of flexible, high tensile strength restraints for connecting with a corresponding lift 74. This arrangement allows the seal frame 75 to decouple from the mechanized lifting columns 74. As such, seal frame 75 may move vertically as a whole based on connections with each of the left and right lifts 74 via flexible restraints. Note that the left lift and right lift 74 and related attachment components are designed for universal use on either the left or right side in mirror image arrangements of each other. As such, the details shown, and their corresponding descriptions, for each side apply to both left and right-side components and features.

A computer system may be programmed to control initial lift operations for raising the uninflated enclosure 73 (FIG. 1A) from a base level via connections with the lifting carriages of lift drive 74 to approximately 55% of the user's height, or in some cases between 50% and 60%, or in other cases 45% to 65%. To facilitate entry and exit, the lift may initially move higher, to approximately between 50-70% of the user's height, and then automatically moved back down to the target height of the ranges previously mentioned. This may facilitate entry and connection to the machine to have the seal frame initially higher during the connection process or “zip-in” process, but then lower in the proper position to facilitate running and movement and to keep the inflatable enclosure out of the way of the arm swing of the user.

Based on research, development, and testing, advantageous combinations have been identified for balancing desired motor requirements along with lift parameters such as lead screen diameter, lead screw pitch, lift speed, and providing the same as part of a lift system that is non-backdrivable. The lift system, which can have non-backdrivable features, may permit operational use of the lift system as a hybrid framework for DAP system operations at high system loads from inflation pressure impacts that cannot readily be retained by the lift column motors and/or without requiring usage of high-capacity motors and related lift framework components. Further, for safety purposes, the power to the lift column motors may be arranged to be cut off whenever the lift columns are not in operation in order to ensure that they cannot be overheated due to trying to retain the lifting force and resisting movement of the screw, which may be driven by high restraining forces.

The lift columns or vertical lifts 74 may be built efficiently with certain features, such as sliding rails and a cable channel. A smooth inner surface and rounded corners on the inner surface may protect the shell from abrasion as the lift column moves up and down during use. Channel blockades and a minimized channel gap may prevent or eliminate potentially pinch hazards. Putting the lifting carriage on the outside of the lifting column may also avoid abrasion of the enclosure 73 and provide more width to the machine so that the angles of the ropes may be at a desired angle β, which may, for example, be about or approximately 45 degrees. However, with the lifting carriages arranged on the outside, if there is a gap with the lead screw, there is an increased chance of a pinch hazard and reducing this gap to less than, for example, 8 mm may enhance safety. A center guard may therefore be used where a section of the lift column protrudes through the lift column gap on either side, but the size of this protrusion may be less than about 8 mm without the gap creating a pinch hazard. These and related beneficial features can be incorporated into the designs of exemplary vertical lifts 74.

As may be seen in FIGS. 1A and 1B, each vertical lift 74 may include a motor mounted at a base portion and firmly retained with the attachment of each vertical lift to the platform. The motors may spin quickly and drive a planetary gearbox during lift operations, which may create noise that may be amplified by metal structures. However, such noise and related sounds may be minimized via installation of each motor within a base portion of each lift that it is firmly secured to platform 72, including rigid attachment to a lift bracket.

### Exemplary Screw Drive Lift Columns

Referring now to FIGS. 1C to 4, an example lift column 70 is shown, which is a lead screw rail linear drive system 74 that can be incorporated into the example DAP system 70 illustrated in FIGS. 1A-1B and/or other related systems and apparatuses. Although shown as components of a DAP system 70 for illustrative purposes, it should be understood that the linear drive system 74 may be used with various other systems, devices, and applications.

In certain embodiments, the linear drive system 74 may be comprised of an extrusion 11 (which, in some cases, can be an aluminum extrusion), a lead screw 12 held in place at the bottom with a bearing housing 13 and at the top with a bearing 14 that inserts into a top plate 15, driven by, for example, a 24 V (volt) planetary gear motor 16. A carriage 17 is configured to ride up and down the lead screw 12. The inflatable enclosure 73 (FIGS. 1A and 1B) attaches to a connection structure 18 (FIG. 1E), which can be a machined aluminum part in some examples, that is in turn attached to the carriage 17, and therefore runs up and down on the outer face of the extrusion 11. A cover 19, which may include a formed sheet-metal cover, shields and/or covers the length of the lead screw 12 to prevent pinch point access and mitigate the amount of dust that can get inside.

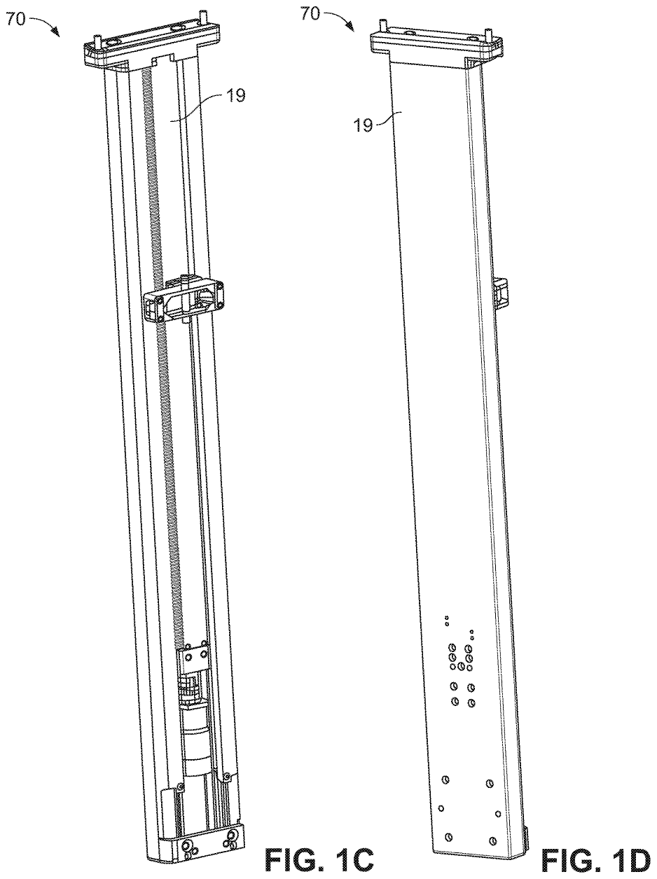

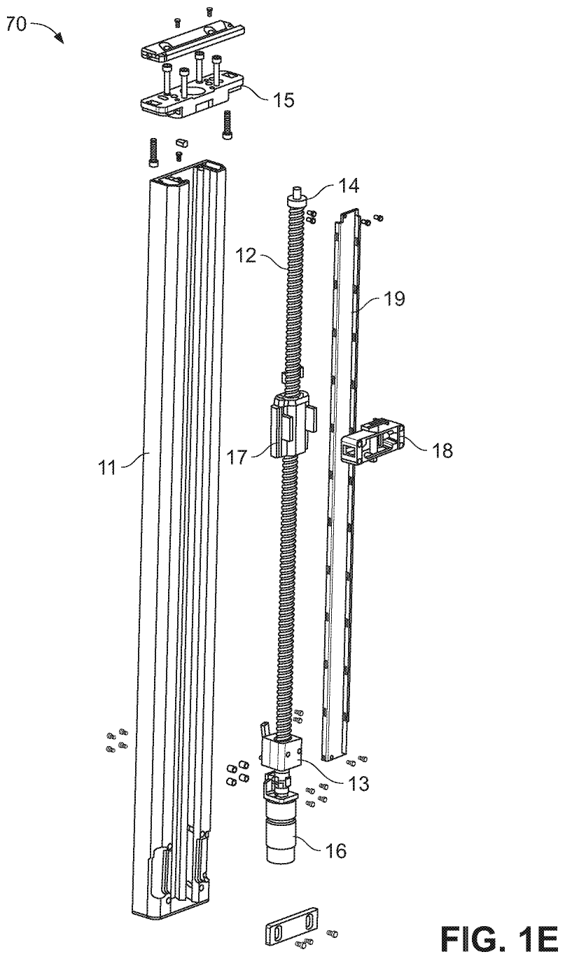

As best illustrated by the cross-sectional profile 21 of the extrusion 11 in FIG. 2, the extrusion may, for example, incorporate two circular profile rails 22, each of which may, for instance, have a diameter of about ten (10) mm. Further, the rails 22 may be spaced apart, for example, about sixty (60) mm. FIG. 3 shows the carriage 17 that is supported on the extrusion rails 22 via four (4) polymer linear bearings 31.

According to an original design option, a lead nut, which may be constructed of brass or other appropriate material, was press-fit into the carriage near its center 32. The lead screw 12 may, for example, include a 22×5 mm trapezoidal lead screw 12, the rotation of which drives the carriage up and down the column.

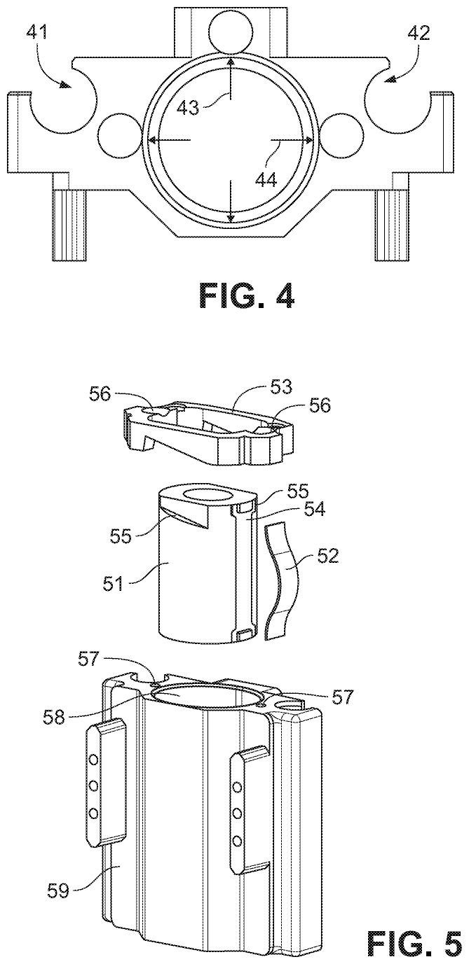

An anti-chatter lead nut 80 may include three parts as shown in FIG. 5: a threaded body 51; a linear wave spring 52; and a cap 53. The threaded body 51 may, for example, be formed as a Tr 22 mm×5 mm threaded body 51 having a ~1.190″ exterior diameter and ~1.900″ tall cylinder. On one lateral surface, a vertical slot 54 may be machined or otherwise integrated having dimensions, for example, of approximately 0.380″×1.580″, to hold in place a linear wave spring 52. The wave spring may include, for instance, a wave spring from Smalley Inc. (e.g., Part #LS 12375-1). Relevant spring specs may, for example, be 1.5″ long×0.012″ thick×0.375″ wide, providing 3.5 lbs spring force. The spring can operate to push the threaded body 51 against the lead screw. Although the system may tolerate a higher spring force, it would be at the expense of more friction, i.e., more wear and more power required to drive the carriage.

Two flat surfaces 55 on opposite sides near the top of the threaded body 51 may be machined, for example, at an angle of ~12 degrees to the horizontal. The angle was determined by measuring the angle at which a flat block of the polymer lead nut material begins to slide on the cap 53, which may be constructed of aluminum material. The tangent of this angle can be defined as the static coefficient of friction, μ, between these two materials μ=tan 12°=0.21. What this means is that with any angle equal to or greater than 12 degrees, an axial force pushing the threaded body 51 up against the cap 52 will cause the threaded body to slide up the ramp of the cap 52. Because the cap 52 is screwed to the carriage through clearance holes 56 in the cap 52 and threaded holes 57 in the carriage, an upward axial force will displace the threaded body laterally and up against the lead screw, adding to the force supplied by the linear wave spring. Through testing and experimentation, it was found that this additional force was significantly contributed to eliminating chatter.

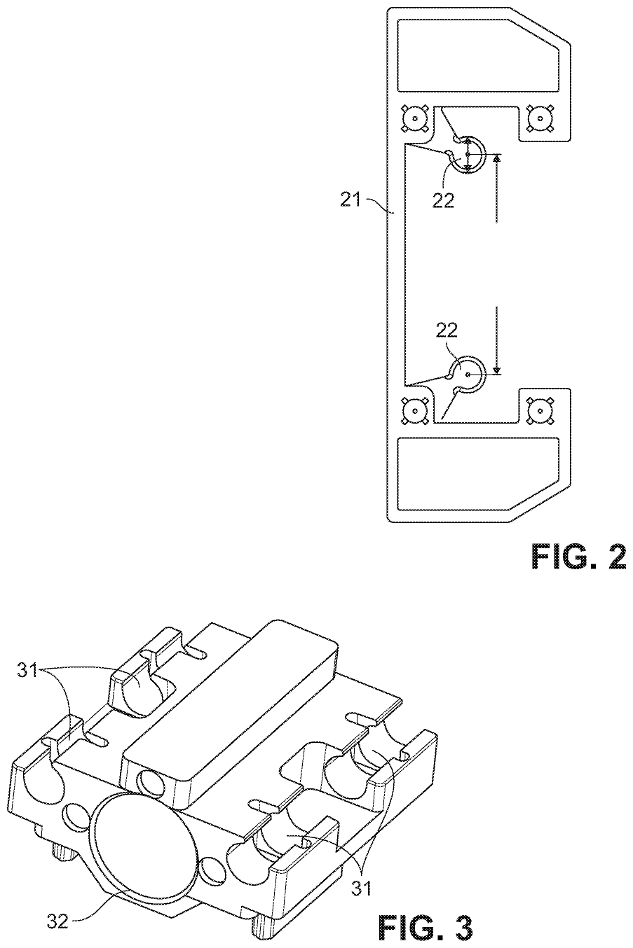

The threaded body 51 can be considered to be truly floating within the carriage 59 because it moves freely with clearance between the threaded body 51 and the cap 52, and clearance between the threaded body 51 and carriage bore 58. Referring to FIG. 4, the carriage bore 58 is an oval in this design with the minor diameter 43 a few thousandths larger than the threaded body 51 external diameter, and a major diameter 44 approximately 0.100″ larger than the external diameter of the threaded body 51. Again, none of these dimensions is critical for the nut to function.

An assembly method may include an action of inserting the linear wave spring 52 in slot 54 on the vertical surface of the threaded body 51, and continue with an action of inserting the threaded body 51 along with spring 52 into the carriage bore 58. Method may continue with an action of attaching the cap 52 to the carriage 59 with two screws that are screwed into threaded holes 57 on the carriage 59.

In certain embodiments, a purpose of the column assembly is to adjust automatically-based on user height-the height of the inflatable enclosure waist seal position during the zip-in procedure and then adjust the waist seal position for exercise. During the zip-in procedure phase, the right-side and left-side carriages only lift the inflatable enclosure assembly weight and overcome some friction as the inflatable enclosure rides up or down the lift column. It was noted that on cold days, the unfolding of the cold PVC inflatable enclosure increases the lifting resistance force significantly over the inflatable enclosure's dead weight. Using a spring force gauge, a lifting force was measured in the range between 15 to 30 lbs on each side. After zip-in, the inflatable enclosure height can be adjusted for exercise. The inflatable enclosure height above the treadmill deck can be held in position, and the inflatable enclosure can be pressurized to a level dependent on a user-selected desired percent unweighting.

Constraining the inflatable enclosure to a height below its fully-inflated height exerts an upward force that is resisted by the lift columns. The magnitude of the force on each column is a function of the inflatable enclosure pressure and height of the inflatable enclosure in relation to its fully-inflated height. A fully-inflated enclosure, regardless of the internal inflatable enclosure pressure, exerts essentially no lift force on the columns, whereas an inflatable enclosure adjusted to its lowest height and inflated to maximum pressure exerts an upward force of 500 to 600 lbs on each lift column. Lateral forces applied to the lift columns from the inflated inflatable enclosure exist as well, but are not considered here. Thus, during a session, each lift column assembly must be able to move a relatively low load rapidly and then hold the carriage in place when subjected to a significantly higher upward load for the duration of an exercise session.

Instead of a circular bore in the carriage on both sides FIG. 4, the housing bore 41 for the two linear bearings on one side is circular, and the housing bore 42 for the two linear bearings on the other side is an oval, which becomes the floating bearing side, allowing the bearing to slide freely laterally to accommodate a tolerance of ±0.86 mm. Testing over thousands of cycles has shown this configuration to provide a robust and cost-effective solution.

The high vertical inflatable enclosure load when under operating pressure is transmitted from the inflatable enclosure to the carriage 17 and connection structure 18 to the lead screw 12 and then to the lift column extrusion 11 and frame through the bottom lead screw bearing housing 13. In the original design, the bearing housing was over-constrained by fastening it to both the back wall of the extrusion and the front of the extrusion. Because the extrusion did not match the model perfectly, dimensions were off and tightening both the front and back of the housing pulled the lead screw attachment out of alignment. The housing and lift column vibrated, the motor wobbled, and current and noise increased. Additionally, this design contributed to lead screw chatter as well. To overcome these challenges, one solution is to attach the housing to the back wall only, with hardened pins designed to locate the bearing housing, and therefore the lead screw, and to carry the inflatable enclosure load.

The critical speed of a lead screw is the rotational speed, e.g., the RPM (rotations per minute) at which point the spinning lead screw becomes unstable and reaches resonance. As a rule of thumb, a system should not operate above 80% of the critical speed. Critical speed is a function of lead screw length, the end conditions, lead screw diameter, and mass density of the lead screw. Another factor affecting critical speed would include straightness. Critical speed is inversely proportional to L2, the square of the lead screw length, L. To improve lift column performance, the length of the lead screw can be reduced by approximately 15%, thereby increasing the critical speed by approximately 38%. The dimensions described below are specific to one lift column design. However, in this design, few, if any, dimensions require high precision, and high-precision molding or machining is therefore not required. The dimensions are provided only to illustrate the described concept.

In certain embodiments, the system can operate closer to the critical speed of a lead screw than other lead nut designs. Since critical speed is a function of screw length, screw diameter, and RPM, this means that many options open up. For example, lead screws could be longer, smaller in diameter, or run faster.

Replacement of a lead nut is straightforward since no special tools are required. For example, a cap can be unscrewed and removed, an existing lead nut can be removed, a replacement lead nut can be inserted, and the cap can then be reattached. In addition, the design has been shown to operate with both unlubricated plastic nuts, as well as with brass nuts. By comparison, earlier plastic nuts, particularly when used without lubrication, produced unacceptable chatter and were unsuitable for higher-speed operation.

### Lubrication

Brass lead nuts running on cold-rolled-steel lead screws typically require lubrication to reduce friction and prevent corrosion of the lead screw. The DAP systems described herein can use lithium-based greases in some embodiments, although no standard has been specified. To reduce maintenance and reduce the mess associated with grease, testing and experimentation stages explored replacing the brass nut with a polymer nut having a solid lubricant embedded therein, such as nylon having embedded molybdenum disulfide, as well as a cold-rolled steel lead screw with a stainless lead screw. Any appropriate lubrication can be incorporated with any of the embodiments described herein.

### Dual Anti-chatter Nuts

In the embodiment described in FIG. 5, only the top of the anti-chatter nut threaded body 51 has two flat surfaces 55 machined at 12 degrees to the horizontal. This is the bearing surface when the lead nut is pushing on the carriage vertically upwards. In this configuration, the axial upward force acting on the cap 53 forces the lead nut laterally against the lead screw. The opposite side of the lead nut has a flat bearing surface.

When the force direction is reversed and the lead nut pushes downward on the carriage, there is no equivalent component of force acting on the lead nut to push it laterally against the lead screw. Only the linear wave spring 52 is acting to push the lead nut 51 against the lead screw. It may occur under some circumstances that this condition will induce chatter.

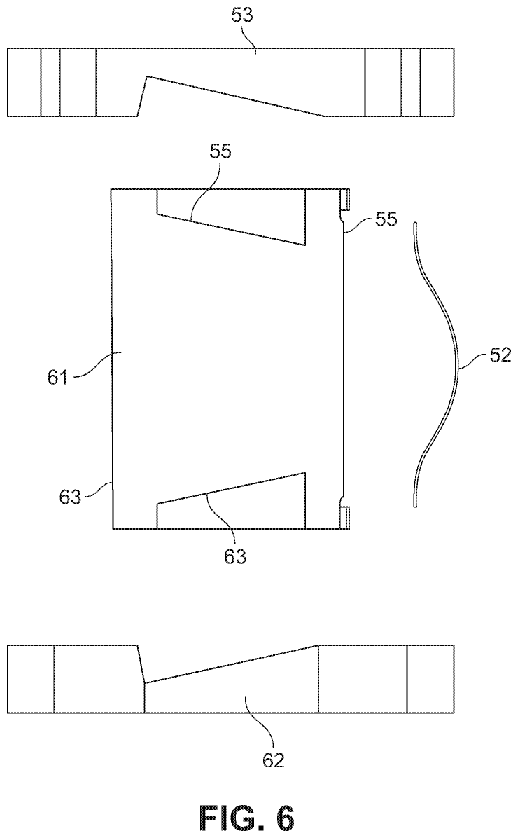

An alternate design as shown in FIG. 6. In this embodiment, the anti-chatter lead nut 61 has two flat surfaces machined on each end of the anti-chatter nut-the two surfaces 55 at the top and the two new surfaces at the bottom 63, both at 12 degrees to the horizontal in this embodiment. The anti-chatter lead nut 61 floats within the chamber, and is held in place by the original cap 53 and the new cap 62. The angle of the oblique flat surface of the cap 62 also can be about 12 degrees.

The angle of 12 degrees was chosen because it was the angle at which the polymer lead nut material slid on a polished surface of aluminum, the cap material. The tangent of this angle is the static coefficient of friction. Other material combinations will have different coefficients of friction and, therefore, different angles may be chosen.

A smaller angle produces higher precision. With the linear wave spring 52 augmenting the force produced by the angled or slanted flat surfaces 55 and 63, smaller angles on the order of 6 degrees may eliminate the chatter in some embodiments.

The subject matter described above is provided by way of illustration only and should not be construed as limiting. Various modifications and changes may be made to the subject matter described herein without following the example arrangements, embodiments and applications illustrated and described, and without departing from the true spirit and scope of the embodiments, arrangements, or of the concepts and technologies disclosed herein.

Although various arrangements and embodiments have been described as having particular features and/or combinations of components, other embodiments and arrangements are possible having a combination of any features and/or components from any of embodiments or arrangements as discussed above. Aspects have been described in the general context of exercise devices, and more specifically supplemental lifting, unweighting or differential air pressures mechanisms, devices, systems, and methods for exercise devices, but inventive aspects are not necessarily limited to use with exercise devices.

In certain embodiments, a lift column can include a lead screw having external threads extending substantially along a length of the lead screw and operatively connected at a first end region to a drive motor, a lead nut threadingly mated with the lead screw and having internal threads engaging a corresponding region of the external threads, a housing defining an interior bore therethrough disposed about an exterior of the lead nut, and a bias member. A gap can be defined between the interior bore and the exterior of the lead nut such that the lead nut floats within the housing. The bias member can be connected at a first side to a first one of a lateral portion of the lead nut and the housing interior bore, and at an opposite second side to a second one of the lateral portion of the lead nut and the housing interior bore, such that the bias member applies a lateral force against the floating lead nut. The internal threads of the lead nut can be biased against the external threads of the lead screw during rotation of the lead screw to eliminate or mitigate chatter while traveling along the length of the lead screw.

In certain embodiments, the lift column can be non-backdrivable under a static load.

In certain embodiments, the static load can be 500 pounds or greater.

In certain embodiments, the lift column can further include a cap attached to a top portion of the housing, the cap defining an opening therethrough, with the lead screw extending through the opening. A bottom surface of the cap can include a pair of slanted contact surfaces, each disposed on opposite sides of the lead screw. An upper surface of the lead nut can include a mating pair of slanted contact surfaces, each disposed on opposite sides of the lead screw. The pairs of slanted contact surfaces can abut one another during operation of the lift column.

In certain embodiments, the cap can be a top cap, the opening can be a top opening, and the pairs of slanted contact surfaces can be pairs of upper contact surfaces. The lift column can further include a bottom cap attached to a bottom portion of the housing, the bottom cap defining a bottom opening therethrough, with the lead screw extending through the bottom opening. A top surface of the bottom cap can have a pair of lower slanted contact surfaces disposed on opposite sides of the lead screw. A lower surface of the lead nut can have a mating pair of lower slanted contact surfaces on opposite sides of the lead screw. The pairs of lower slanted contact surfaces can abut one another during operation of the lift column.

In certain embodiments, the lateral force can be a lateral spring force that ranges from about 3.5 pounds to about 5 pounds.

In certain embodiments, the lead nut can be constructed from at least one of brass or a polymer having a solid lubricant embedded therein.

In certain embodiments, the polymer can comprise nylon and the solid lubricant can comprise molybdenum disulfide.

In certain embodiments, the lead screw can be adapted to operate at a speed within 20% of a resonant speed of the lead screw.

In certain embodiments, the housing interior bore can be substantially oval-shaped, and the housing can define a pair of rail bearings at opposite sides. One of the pair of rail bearings can have an oval shape and can be adapted to float laterally inside the housing on one side.

In certain embodiments, a linear drive system can include a lead screw having external threads and configured to be operatively coupled to a drive motor, a lead nut having internal threads that are threadingly mated with the external threads of the lead screw, a housing defining an interior bore therethrough that is disposed about an exterior of the lead nut, and a bias member adapted to apply a lateral force against the floating lead nut. A gap can be defined between the interior bore and the exterior of the lead nut such that the lead nut floats within the housing. The bias member can be connected at a first side to the lead nut and at a second side to the interior bore of the housing. During rotation of the lead screw by the drive motor, the internal threads of the lead nut can be biased against the external threads of the lead screw as the lead nut moves along the external threads of the lead screw.

In certain embodiments, the linear drive system can further include a retaining cap coupled to the housing and configured to retain the lead nut within the interior bore. The lead nut and the retaining cap can include corresponding angled contact surfaces configured to convert axial loading on the lead nut into an additional lateral force that biases the lead nut toward the lead screw.

In certain embodiments, the lead nut can include at least one first angled contact surface at a first end of the lead nut and at least one second angled contact surface at a second end of the lead nut such that axial loading of the lead nut in either direction generates the additional lateral force biasing the lead nut toward the lead screw.

In certain embodiments, the corresponding angled contact surfaces can define an angle selected based, at least in part, on a static coefficient of friction between a material of the lead nut and a material of the retaining cap.

In certain embodiments, the retaining cap can be removably coupled to the housing to permit removal and replacement of the lead nut from the interior bore.

In certain embodiments, the bias member can comprise a linear wave spring positioned between a lateral portion of the lead nut and the interior bore of the housing.

In certain embodiments, the linear drive system can be non-backdrivable such that the lead screw and the lead nut are configured to resist rotation of the lead screw in response to an axial load applied to the lead nut and the linear drive system holds a position of the lead nut when the drive motor is unpowered.

In certain embodiments, the lead nut can comprise a polymer material having a solid lubricant embedded therein.

In certain embodiments, the interior bore can have a substantially oval shape configured to permit lateral movement of the lead nut within the housing.

In certain embodiments, the linear drive system can be incorporated into a lift column configured to raise, lower, and hold a supported component at a selected height.

In certain embodiments, the lift column can be incorporated into a differential air pressure (DAP) system and can be configured to adjust a height of an inflatable enclosure or a seal frame of the differential air pressure system.

While various novel features have been shown, described, and pointed out as applied to particular embodiments thereof, it should be understood that various omissions and substitutions, and changes in the form and details of the systems and methods described and illustrated, may be made by those skilled in the art without departing from the spirit of the embodiments described herein. Amongst other things, the steps in the methods may be carried out in different orders in many cases where such may be appropriate. Those skilled in the art will recognize, based on the above disclosure and an understanding of the teachings herein, that the particular hardware and devices that are part of the system described herein, and the general functionality provided by and incorporated therein, may vary across different embodiments. Accordingly, the description of system components are for illustrative purposes to facilitate a full and complete understanding and appreciation of the various aspects and functionality of particular embodiments as realized in system and method embodiments thereof. Those skilled in the art will appreciate that the embodiments described herein can be practiced in other ways than the described embodiments, which are presented for purposes of illustration and not limitation. Variations, modifications, and other implementations of what is described herein may occur to those of ordinary skill in the art without departing from the spirit and scope of the present disclosure and its claims.

1. A lift column comprising:
a lead screw having external threads extending substantially along a length of the lead screw and operatively connected at a first end region to a drive motor;
a lead nut threadingly mated with the lead screw having internal threads engaging a corresponding region of the external threads;
a housing defining an interior bore therethrough disposed about an exterior of the lead nut, wherein a gap is defined between the interior bore and the exterior of the lead nut such that the lead nut floats within the housing; and
a bias member connected at a first side to a first one of a lateral portion of the lead nut and the housing interior bore, and at an opposite second side to a second one of the lateral portion of the lead nut and the housing interior bore, such that the bias member applies a lateral force against the floating lead nut;
wherein the internal threads of the lead nut are biased against the external threads of lead screw during rotation of the lead screw to eliminate or mitigate chatter while traveling along of the length of the lead screw.

2. The lift column of claim 1, wherein the lift column is non-backdrivable under a static load.

3. The lift column of claim 2, the static load is 500 pounds or greater.

4. The lift column of claim 1, further comprising a cap attached to a top portion of the housing, the cap defining an opening therethrough and the lead screw extending through the opening;
wherein:
a bottom surface of the cap includes a pair of slanted contact surfaces, each of which disposed on opposite sides of the lead screw;
an upper surface of the lead nut having a mating pair of slanted contact surfaces each disposed on opposite sides of the lead screw; and
the pairs of slanted contact surfaces abut one another during operation of the lift column.

5. The lift column of claim 4, wherein the cap is a top cap, the opening is a top opening, and the pairs of slanted contact surface are pairs of upper contact surfaces, the lift column further comprising:
a bottom cap attached to a bottom portion of the housing, the bottom cap defining a bottom opening therethrough and the lead screw extending through the bottom opening;
wherein:
a top surface of the bottom cap having a pair of lower slanted contact surfaces disposed on opposite sides of the lead screw;
a lower surface of the lead nut having a mating pair of lower slanted contact surfaces on opposite sides of the lead screw; and
the pairs of lower slanted contact surfaces abut one another during operation of the lift column.

6. The lift column of claim 1, wherein the lateral force is a lateral spring force that ranges from about 3.5 pounds to 5 pounds.

7. The lift column of claim 1, wherein the lead nut is constructed from at least one of: brass; and a polymer having a solid lubricant embedded therein.

8. The lift column of claim 7, wherein the polymer comprises nylon and the solid lubricant comprises molybdenum disulfide.

9. The lift column of claim 1, wherein the lead screw is adapted to operate at a speed within 20% of a critical speed thereof.

10. The lift column of claim 1, wherein the housing interior bore is substantially oval-shaped, the housing defines a pair of rail bearings at opposite sides, wherein one of the pair of rail bearings has an oval shape and is adapted to float laterally inside the housing on one side.

11. A linear drive system comprising:
a lead screw having external threads and configured to be operatively coupled to a drive motor;
a lead nut having internal threads that are threadingly mated with the external threads of the lead screw;
a housing defining an interior bore therethrough that is disposed about an exterior of the lead nut, wherein a gap is defined between the interior bore and the exterior of the lead nut such that the lead nut floats within the housing; and
a bias member adapted to apply a lateral force against the floating lead nut, wherein the bias member is connected at a first side to the lead nut, and at an second side to the interior bore of the housing;
wherein, during rotation of the lead screw by the drive motor, the internal threads of the lead nut are biased against the external threads of the lead screw as the lead nut moves along the external threads of the lead screw.

12. The linear drive system of claim 11, further comprising:
a retaining cap coupled to the housing and configured to retain the lead nut within the interior bore, wherein the lead nut and the retaining cap include corresponding angled contact surfaces configured to convert axial loading on the lead nut into an additional lateral force that biases the lead nut toward the lead screw.

13. The linear drive system of claim 12, wherein the lead nut includes at least one first angled contact surface at a first end of the lead nut and at least one second angled contact surface at a second end of the lead nut such that the axial loading of the lead nut in either direction generates the additional lateral force biasing the lead nut toward the lead screw.

14. The linear drive system of claim 12, wherein the corresponding angled contact surfaces define an angle selected based, at least in part, on a static coefficient of friction between a material of the lead nut and a material of the retaining cap.

15. The linear drive system of claim 12, wherein the retaining cap is removably coupled to the housing to permit removal and replacement of the lead nut from the interior bore.

16. The linear drive system of claim 11, wherein the bias member comprises a linear wave spring positioned between a lateral portion of the lead nut and the interior bore of the housing.

17. The linear drive system of claim 11, wherein the linear drive system is non-backdrivable such that the lead screw and the lead nut are configured to resist rotation of the lead screw in response to an axial load applied to the lead nut and the linear drive system holds a position of the lead nut when the drive motor is unpowered.

18. The linear drive system of claim 11, wherein the lead nut comprises a polymer material having a solid lubricant embedded therein.

19. The linear drive system of claim 11, wherein the interior bore has a substantially oval shape configured to permit lateral movement of the lead nut within the housing.

20. The linear drive system of claim 11, wherein the linear drive system is incorporated into a lift column configured to raise, lower, and hold a supported component at a selected height.

21. The linear drive system of claim 20, wherein the lift column is incorporated into a differential air pressure (DAP) system and is configured to adjust a height of an inflatable enclosure or a seal frame of the differential air pressure system.
